(19) United States
(12) Patent Application Publication
(10) Pub. No.: US 2022/0185020 A1
(43) Pub. Date: Jun. 16, 2022

(54) TRUCK TIRE

(71) Applicant: The Goodyear Tire & Rubber Company, Akron, OH (US)

(72) Inventors: Ettore Passante Spaccapietra, Ettelbruck (LU); Denis Jean Rene Gerard, Arlon (BE); Didier Winkin, Bastogne (BE); Arun Prasath Manogaran, Everlange (LU); Philippe Joseph Auguste Muller, Champlon (BE)

(21) Appl. No.: 17/120,323

(22) Filed: Dec. 14, 2020

(51) Int. Cl. B60C 9/20

(52) U.S. Cl. CPC B60C 9/2006; B60C 9/28; B60C 9/2009

(57) ABSTRACT

A pneumatic tire for use on trucks, the tire comprising: a tread which includes a belt reinforcement structure, the belt structure including a pair of working belts, wherein the angle of the working belts range from about 10 degrees to about 50 degrees, and wherein the first working belt has an angle of the reinforcements different that the angle of the belt reinforcements of the second working belt. The belt package further includes a low angle belt that is preferably positioned between of the working belts, wherein the angle of the low angle belt is less than 5 degrees. The working belts and the low angle belt are extensible, and preferably made of high elongation wire. The pneumatic tire further includes a wherein the tread is formed of a treadcap compound having a tensile at break greater than 18 MPa, and an elongation at break greater than 450%.

### FIELD OF THE INVENTION

The invention relates in general to pneumatic tires, and more particularly for heavy vehicles such as trucks.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability, and improved resistance to groove cracking and increased load carrying capacity is desired.

### SUMMARY OF THE INVENTION

The invention provides in a first aspect a pneumatic tire for use on trucks, wherein the tire has a tread and a belt reinforcement structure located radially inward of the tread, the belt structure including a first and second working belt, wherein the first and second working belts are formed of extensible reinforcements, wherein the angle of the first and second working belts range from about 10 degrees to about 50 degrees as measured relative to the circumferential direction; wherein the belt structure further comprises a low angle belt having reinforcements angled at less than 5 degrees relative to the circumferential direction, and wherein the low angle belt has extensible reinforcements; wherein the tread is formed of a tread compound having a tensile at break greater than 18 MPa, and an elongation at break greater than 450%, when measured at 23 deg C.

The invention provides in a second aspect a pneumatic tire for use on trucks, the tire having a tread and a belt reinforcement structure located radially inward of the tread, the belt structure including a first and second working belt, wherein the angle of the first and second working belts range from about 10 degrees to about 50 degrees as measured relative to the circumferential direction; wherein the belt structure further comprises a low angle belt having reinforcements angled at less than 5 degrees relative to the circumferential direction, and wherein the low angle belt has extensible reinforcements; and wherein the tread is formed of a tread compound having a tensile at break greater than 12 MPa, and an elongation at break greater than 600%, when measured at 100 deg C.

### Definitions

“About” means, unless otherwise specified, +/−10%.

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cord having a relative elongation at break of greater than 0.2% at 10% of the breaking load, when measured from a cord extracted from a cured tire. The tensile measurements for elongation at break (total elongation in %) are performed in accordance with ISO 6892-1B(2019) at preload no more than 25 mpa tested on a cable or cord when taken from a cured tire.

“Inner Liner” means the layer or layers of elastomer or other material that form the inside surface of a tubeless tire and that contain the inflating fluid within the tire.

“Inserts” means the reinforcement typically used to reinforce the side edges of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Side edge” means a portion of a tire between the tread and the bead.

“Sipe” means small slots or elongated void areas typically formed by thin steel blades, and which tend to remain closed, and function to increase traction.

“Laminate structure” means an unvulcanized structure made of one or more layers of tire or elastomer components such as the innerliner, side edges, and optional ply layer.

### BRIEF DESCRIPTION OF THE DRAWINGS

The invention will be described by way of example and with reference to the accompanying drawings in which:

FIG. 1 is a cross-sectional view of a first embodiment of a tire of the present invention; and

FIG. 2 is a close-up view of the belt package of the tire of FIG. 1.

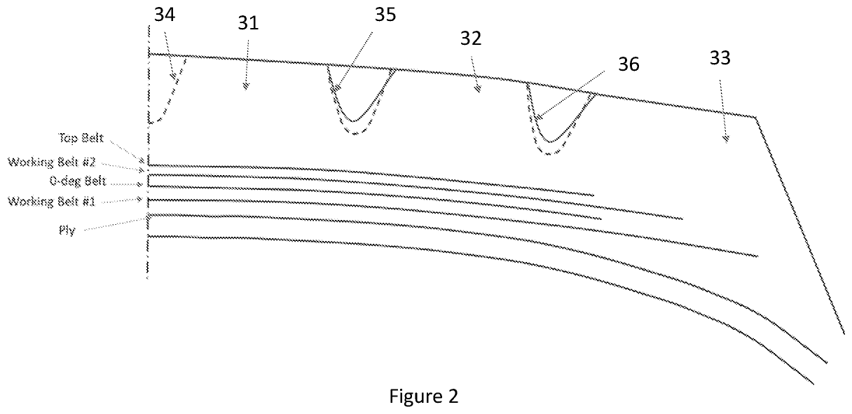

### DETAILED DESCRIPTION OF THE INVENTION

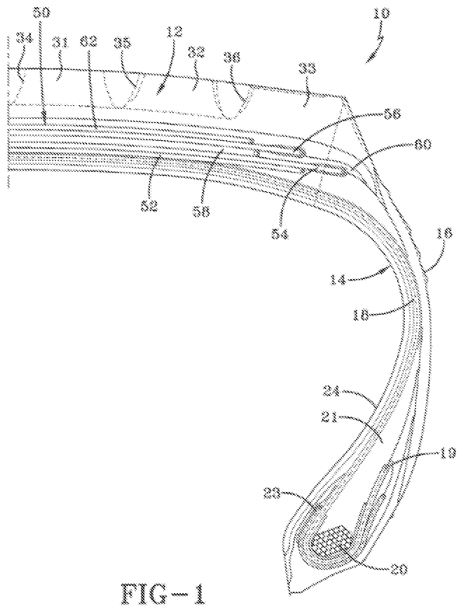

FIG. 1 illustrates a first embodiment of one half of a pneumatic tire 10, suitable for use as a truck tire. The tire 10 has a tread 12 with a non-skid depth D. The tire tread 12 may comprise a plurality of circumferentially continuous ribs, which may vary, but are shown for example as ribs 31, 32 and 33. Positioned between each rib is a circumferential groove 34, 35, 36, which are preferably continuous. The tire tread is preferably formed of a treadcap compound having the following properties: a tensile strength at break greater than 18 MPa, when measured at 23 C. The treadcap compound further has an elongation at break greater than 450% when measured at 23 C. Under higher temperature conditions, it is preferred that the treadcap compound have a high temperature tensile strength at break greater than 18 MPa, when measured at 100 deg C. It is additionally preferred that the treadcap compound have an elongation at break greater than 12 MPA when measured at 100 deg C.

The tensile measurements such as the load at break (maximum load in N), strength at break (in MPa) and elongation at break (total elongation in %) are performed in tension in accordance with DIN 53504-2009-10 on out of tire cured samples at the temperature specified, above.

The tire 10 further comprises a casing 14 which includes two opposed sidewalls 16 which extend down from the tread 12 to the bead area. The casing of the tire may optionally include an inner liner 24 which is typically formed of halobutyl rubber which forms an air impervious barrier. The tire casing 14 further includes one or more radial plies 18 extending from the tread, down the sidewall to the tire bead 20. Preferably the radial ply 18 is wrapped about or otherwise secured to each annular bead 20. In the embodiment illustrated and not limited to same, there is only one ply 18 and it is wrapped around the bead in an inside out manner such that the ply ending 19 is located axially outward and radially outwards of the bead. The beads 20 may be any desired shape, but in this embodiment, it is shown as a hexagonal configuration with steel filaments.

The tire may further optionally include an apex 21 which may be shaped like a triangle. The ply turnup in the bead area may be optionally reinforced with a chipper 23 wrapped about the bead ply 18.

Aspect Ratio

The aspect ratio of the tire described above may vary. The aspect ratio is preferably in the range of about 45 to about 80. The tire may have a net to gross ratio in the range of about 60 to about 90, more preferably in the range of about 65 to about 88, more preferably about 70 to 85.

The tire 10 further includes a belt package 50 which is located between the tread and the one or more plies 18. The belt package may be comprised of one or more layers of reinforcement. The ply 18 and the belt reinforcing structure 50 are made from cord reinforced elastomeric material, wherein the cords are typically steel wire or polyamide filaments and the elastomer preferably being rubber.

Working Belts 54,56

Belt reinforcing structure 50 further includes a first and second extensible working belt, 54, 56. First working belt 54 is located radially inwards of second working belt 56. Preferably, first working belt 54 has a belt width substantially equal to the tread arc width, and is preferably the widest belt of the belt package 50. The breaker angle of first working belt 54 is between about 10 and 50 degrees, preferably with a right orientation, more preferably in the range of about 14 to about 42 degrees, and more preferably in the range of about 16 to about 35 degrees. First working belt 54 is made of extensible or high elongation wire, and has a % elongation at 10% of breaking load of greater than 0.2%, as measured from a cord taken from a cured tire. Preferably, the % elongation at the 10% of breaking load is greater than 0.4%, and more preferably greater than 0.8%, and most preferably greater than 1.2%. The tensile measurements on the working belts such as the load at break (maximum load in N), strength at break (in MPa) and elongation at break (total elongation in %) are performed in tension in accordance with ISO 6892-1B (2019) at a pre-load no more than 25 MPa tested on a cable or wire when taken from a cured tire.

The first working belt construction is preferably formed of wire having a wire construction of 3×7×, 3×4×, 4×4×. Preferably the wire has a construction of 4+3×, and more preferably, a wire construction of 4+3×0.35 UT. The EPI may range from about 8 to about 14.

The second working belt 56 is located radially outward of the first working belt, and preferably has a width less than the width of first working belt 54. Preferably, the second working belt 56 has a width less than the width of belt 54 by a step off, which may range from about 10 to about 20 mm. Preferably, the gauge cord to cord between the second working belt and the first working belt is less than 6 mm.

Working belt 56 has a breaker angle between about 10 to 50 degrees, and more preferably in the range of about 14 to 42 degrees, preferably with a left orientation, and more preferably in the range of about 16 to about 35 degrees. Preferably, the angle of the first working belt is different than the angle of the second working belt. The angle of either the first or second working belt is the angle of the parallel reinforcement cords relative to the circumferential direction. More preferably, the angle of the first working belt α₁ is greater than the angle of the second working belt α₂. Preferably, the absolute difference of the angle of the first working belt and the angle of the second working belt |α₁-α₂| is greater than 5 degrees. Second working belt 56 is preferably made of high elongation wire, having the same construction with the same but opposite angular orientation as the first working belt 54.

Low Angle Belt 58

The belt structure 50 further comprises a low angle belt 58 which is preferably located between the working pair belts, 54, 56. The low angle belt 58 may also be located between belts 52 and 54 or radially outward of belt 56. The low angle belt 58 has reinforcements that are oriented circumferentially at 5 degrees or less, preferably 0 degrees. The belt is preferably formed from spirally winding a rubberized strip of one or more cords. Preferably the strip has about 1-4 steel cords, and has a strip width less than 15 mm, and more preferably is about 5 mm. Alternatively, the belt may be formed of a cut belt with the reinforcements oriented in the range of 0 to about 10 degrees from the circumferential direction, or more preferably in the range of zero to five degrees from the circumferential direction. The low angle belt 58 has a width sized to avoid compression in the shoulder area. The belt width of low angle belt 58 is preferably less than the belt width of the first and second working belts, and is preferably wider than the top belt 62. The belt structure of the low angle belt 58 may be steel formed of a 3×7 construction, a 3×4 construction, or a 4×4 construction. More preferably, the belt structure of the low angle belt 58 is steel formed of a 3×7×0.22 construction, a 3×4×0.26 construction, or a 4×4×0.22 construction, and preferably formed of high tensile steel. The reinforcement cords of the low angle belt 58 are preferably extensible. For measurements taken from bare cords, the % elongation at 10% of breaking load is 0.2 or more, and preferably 0.4% or more, and more preferably 0.6% or more, and most preferably 0.8%. The tensile measurements such as the load at break (maximum load in N), strength at break (in MPa) and elongation at break (total elongation in %) are performed in tension in accordance with ISO 6892-1B (2019) at a pre-load no more than 10 MPa tested on a cable or wire when taken from a cured tire.

Alternatively, the low angle belt may be formed of non-metal reinforcements such as aramid, carbon fiber, or polyketone or POK.

Top Protection Belt

The belt structure may further include a top protector belt 62 that is the radially outermost belt. The top protector belt 62 has a width that is in the range of 80 to 85% of the width of the low angle belt. Preferably, the belt should have the same angle and orientation as the adjacent belt, 56.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire for use on trucks, the tire comprising:
a tread and a belt reinforcement structure located radially inward of the tread, the belt structure including a first and second working belt, wherein the first and second working belts are formed of extensible reinforcements, wherein the angle of the first and second working belts range from about 10 degrees to about 50 degrees as measured relative to the circumferential direction;
wherein the belt structure further comprises a low angle belt having reinforcements angled at less than 5 degrees relative to the circumferential direction;
wherein the low angle belt has extensible reinforcements; and
wherein the tread is formed of a tread compound having a tensile at break greater than 18 MPa, and an elongation at break greater than 450%, when measured at 23 deg C.

2. The tire of claim 1 wherein the angle of the first working belt is different than the angle of the second working belt.

3. The tire of claim 1 wherein first working belt has a belt angle greater than the belt angle of the second working belt.

4. The tire of claim 1 wherein the absolute value of the difference between a belt angle of the first belt minus a belt angle of the second belt is greater than 5 degrees.

5. The tire of claim 1 wherein the tire further includes a top belt, and wherein the width of the low angle belt is greater than the width of the top belt.

6. The tire of claim 1 wherein the working belts are formed of high elongation wire, having a % elongation at 10% of breaking load greater than 0.2%, when taken from wire from a cured tire.

7. The tire of claim 1 wherein the first and second working belts are formed of high elongation wire reinforcements, having a % elongation at 10% of breaking load greater than 0.4%, when taken from wire from a cured tire.

8. The tire of claim 1 wherein the low angle belt is formed of high elongation wire, having a % elongation at 10% of breaking load greater than 0.8%, when taken from wire from a cured tire.

9. The tire of claim 1 wherein the low angle belt is formed of high elongation wire, having a % elongation at 10% of breaking load greater than 1.2%, when taken from wire from a cured tire.

10. A pneumatic tire for use on trucks, the tire comprising:
a tread and a belt reinforcement structure located radially inward of the tread, the belt structure including a first and second working belt, wherein the angle of the first and second working belts range from about 10 degrees to about 50 degrees as measured relative to the circumferential direction;
wherein the belt structure further comprises a low angle belt having reinforcements angled at less than 5 degrees relative to the circumferential direction, and wherein the low angle belt has extensible reinforcements; and
wherein the tread is formed of a tread compound having a tensile at break greater than 12 MPa, and an elongation at break greater than 600%, when measured at 100 deg C.

11. The tire of claim 10 wherein the angle of the first working belt is different than the angle of the second working belt.

12. The tire of claim 10 wherein first working belt has a belt angle greater than the belt angle of the second working belt.

13. The tire of claim 10 wherein the absolute value of the difference between a belt angle of the first belt minus a belt angle of the second belt is greater than 5 degrees.

14. The tire of claim 10 wherein the tire further includes a top belt, and the width of the low angle belt is greater than the width of the top belt.

15. The tire of claim 10 wherein the working belts are formed of high elongation wire, having a % elongation at 10% of breaking load greater than 0.2%, when taken from wire from a cured tire.

16. The tire of claim 10 wherein the first and second working belts are formed of high elongation wire, having a % elongation at 10% of breaking load greater than 0.4%, when taken from wire from a cured tire.

17. The tire of claim 10 wherein the low angle belt is formed of high elongation wire, having a % elongation at 10% of breaking load greater than 0.8%, when taken from wire from a cured tire.

18. The tire of claim 10 wherein the low angle belt is formed of high elongation wire, having a % elongation at 10% of breaking load greater than 1.2%, when taken from wire from a cured tire.

19. The tire of claim 10 wherein the gauge cord to cord between the second working belt and the first working belt is less than 6 mm.

20. The tire of claim 10 wherein the half belt width of the first belt minus the half belt width of the second belt is between 10 mm and 18 mm.
